(19) United States
(12) Patent Application Publication
(10) Pub. No.: US 2011/0301727 A1
(43) Pub. Date: Dec. 8, 2011

(54) INTERNET-SOURCED BEDTIME AUDIO

(75) Inventor: Frederick William Ansfield, San Diego, CA (US)

(73) Assignee: SONY CORPORATION

(21) Appl. No.: 12/792,974

(22) Filed: Jun. 3, 2010

(51) Int. Cl. G06F 17/00; G06F 1/32; G06F 15/16; G04B 47/00

(52) U.S. Cl. 700/94; 368/10; 709/218; 713/324

(57) ABSTRACT

Sleep sound audio (natural or soothing sounds such as fan, airplane, ocean waves, birds, rainforest, etc.) are streamed over the Internet from an audio server to enabled products for the purpose of helping people fall asleep or for other aural therapy.

### FIELD OF THE INVENTION

The present application relates generally to Internet-sourced bedtime audio.

### BACKGROUND OF THE INVENTION

Some people cannot fall asleep easily when distracted by ambient noises and may fall asleep easier/quicker when noises are masked by employing auxiliary sound. Stand-alone “white noise” products attempt to solve this issue but such products usually contain only a limited number of audio tracks from which to choose, e.g., “surf”, “forest”, “white noise”, etc. Furthermore, modem digital TVs typically mute the audio along with deenergizing the video display when entering a power save mode, so that the old tactic of leaving the TV on and tuned to an off-air channel to listen to the “white noise” on the channel can no longer be practiced.

### SUMMARY OF THE INVENTION

As understood herein, multiple products can leverage Internet streaming audio to increase the variety and size of content available for users to listen to without requiring large amounts of local storage in the products' hardware.

Accordingly, a device includes a housing, a display on the housing, and at least one speaker. A network interface is provided. A processor controls the display and speaker and communicates with the Internet through the network interface to execute logic.

As set forth further below, the logic includes presenting, on the display, a user interface (UI) from which a user can select an “on” time. The logic also includes presenting a UI from which a user can select a sleep sound. The sleep sound is an audio program that is a non-voice audio track. At the on time, the selected sleep sound is automatically played on the speaker from an Internet server. Responsive to a determination that a power conservation criterion is present in the device, the display is deenergized and audio muting of the speaker programmed as part of power conservation logic to be muted in the presence of the power conservation criterion is overridden, to continue playing the sleep sound on the speaker.

The sleep sound can be played on the speaker until a user-selected “off” time is reached, at which time the logic ceases playing of the sleep sound on the speaker. The sleep sound may not include voice or instrumental music but only sounds occurring naturally in nature, and/or white noise.

In some embodiments, at the “on” time streaming of the sleep sound from the Internet server is commenced. The device can be an Internet-enabled TV, a digital clock radio, a digital baby monitor including a video camera, or other consumer electronics (CE) device.

In another aspect, a method includes establishing communication between an audio player and an Internet server, and downloading, from the Internet, sleep sound audio from the server to the player for playing the sleep sound audio to help people fall asleep or for aural therapy.

In another aspect, a device includes a housing, a display on the housing, and at least one speaker. A network interface is provided. A processor controls the display and speaker and communicates with the Internet through the network interface to execute logic.

As set- forth further below, the logic includes presenting a user interface on the display listing genres of audio video content sources and, for each source in sub-menu style, genre of programming provided by that source. One of the sources is the Internet and one of the respective genres of programming is “sleep sounds”. Responsive to a user selection of “sleep sounds” a UI is presented on the display from which a user may select a particular audio including white noise sounds and naturally occurring sounds: The logic includes presenting on the display a UI permitting a user to input an on time of day, at which time of day selected audio is automatically streamed from the server and played on the speaker.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is screen shot of an example user interface (UI) for selecting sleep sound streaming on a TV;

FIG. 3 is screen shot of an example user interface (UI) for selecting a particular sleep sound from a list;

FIG. 4 is screen shot of an example UI for selecting sleep sound channel, on, and off times; and

FIG. 5 is a flow chart of example logic in accordance with present principles, it being understood that present logic may be expressed in state logic.

### DETAILED DESCRIPTION OF THE PREFERRED EMBODIMENT

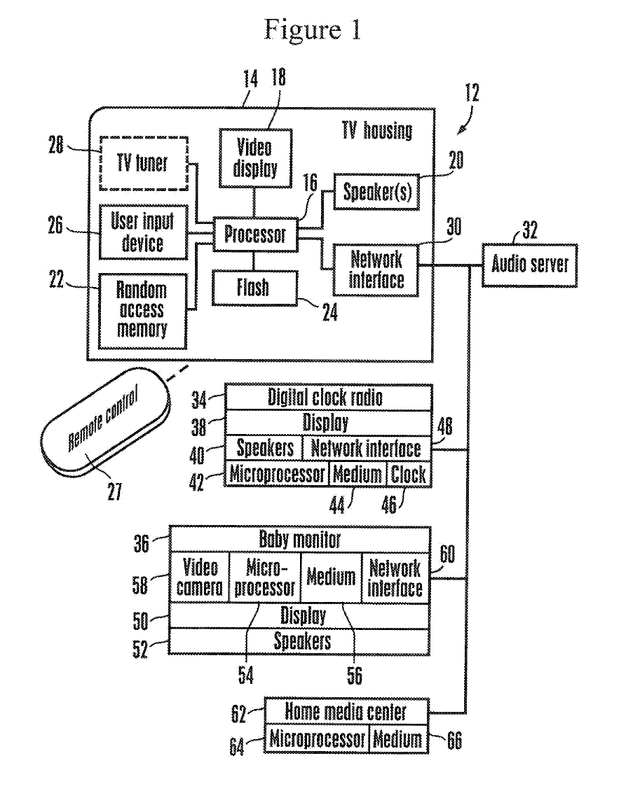

Referring initially to FIG. 1, a TV 12 includes a portable lightweight plastic housing 14 bearing a digital processor 16. The processor 16 can control a visual display 18 and an audible display 20 such as one or more speakers.

To undertake present principles, the processor 16 may access one or more computer readable storage media such as but not limited to RAM-based storage 22 (e.g., a chip implementing dynamic random access memory (DRAM) or a disk drive) or flash memory 24. Software code implementing present logic executable by the TV 12 may also be stored on one of the memories shown to undertake present principles.

The processor 16 can receive user input signals from various input devices 26, including a remote control device 27, a point and click device such as a mouse, a keypad, etc. A TV tuner 28 is typically provided in the housing 14 and may be provided in a set-top box communicating with the TV processor 16 to receive TV signals from a source such as a set-top box, satellite receiver, cable head end, terrestrial TV signal antenna, etc. Signals from the tuner 28 are sent to the processor 16 for presentation on the display 18 and speakers 20.

As shown in FIG. 1, a network interface 30 such as a wired or wireless modem or wireless telephony transceiver communicates with the processor 16 to provide connectivity to one or more audio servers 32 on the Internet. The server 32 has a respective processor and data store for sending multimedia programs including the below-discussed sleep sounds to the TV 12 over the Internet.

Additionally, a user of the TV 12 may also use further CE devices such as digital clock radio 34 and a digital baby monitor 36, and the sleep sounds from the server 32 may also or alternatively be played on these devices within the home as well as on the TV 12.

Other CE devices that may employ present principles include wireless headphones communicating with the Internet using, e.g., WiFi, a game player, a video disk player, a camera, a mobile telephone, a personal digital assistant, a laptop computer, etc.

In the example shown, the clock radio 34 may include a visual display 38 and one or more audio speakers 40 controlled by a clock processor 42 accessing a tangible non-transitory digital storage medium 44 to undertaken present logic. The processor 42 may receive digital clocking signals from an internal digital clock device 46 and may communicate using a network interface 48 with the audio server 32. The network interface 48 may be, e.g., a wired or wireless modem.

The baby monitor 36 may include a visual display 50 and one or more audio speakers 52 controlled by a monitor processor 54 accessing a tangible non-transitory digital storage medium 56 to undertaken present logic. The processor 54 may receive digital video signals from a video camera 58 for display of video therefrom on the display 50 and/or a remote visual display. The processor 54 may communicate using a network interface 60 with the audio server 32. The network interface 60 may be, e.g., a wired or wireless modem.

In addition or alternatively to receiving audio from the audio server 32 over the Internet, the TV 12, clock radio 34, and baby monitor 36 may receive “sleep” audio from a home media center 62 including a media center processor 64 accessing a tangible non-transitory digital storage medium 66.

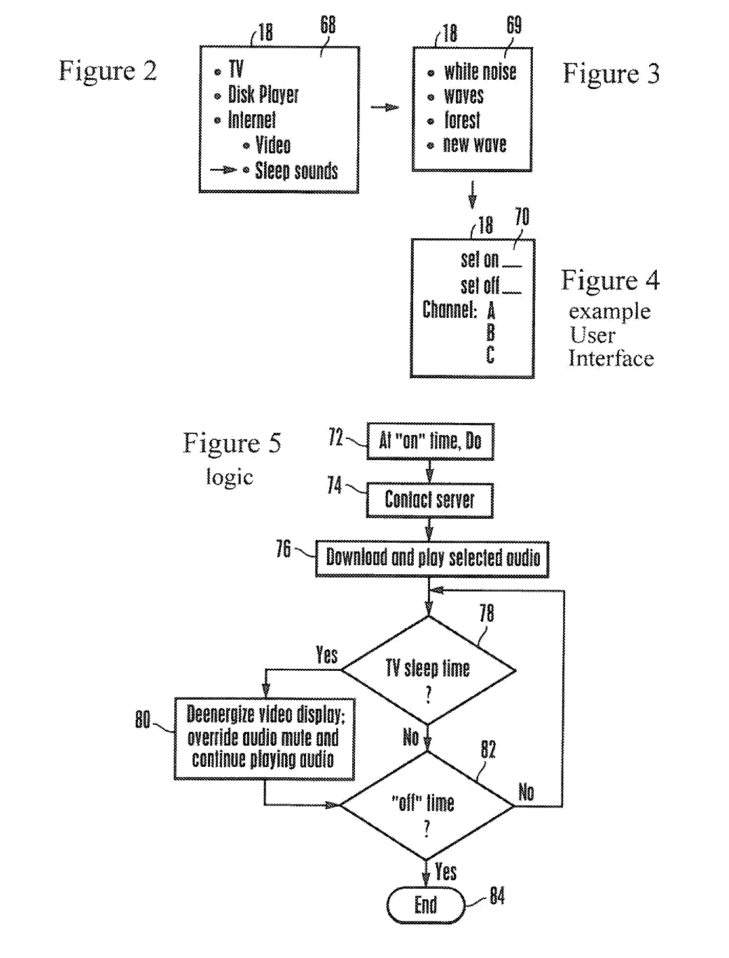

FIG. 2 shows that a user interface (UI) 68 may be presented on, e.g., the TV display 18 listing genres of audio video content sources and, for each source in sub-menu style, genre of programming provided by that source. As shown, one of the sources is the Internet or equivalent wide area computer network term and a partial list of example genres of programming may include “video” and “sleep sounds”. If “sleep sounds” is selected another UI 69 (FIG. 3) may be presented from which the user may select a particular audio type, e.g., “white noise”, “forest sounds”, “waves”. In other words, in one embodiment “sleep sounds” are non-instrumental, non-voice audio tracks sounds occurring naturally in nature such as ocean waves, bird sounds, and forest sounds, in some cases along with other non-instrumental non-voice sounds such as white noise sounds, e.g., fan sounds, airplane sounds. In another embodiment, “sleep sounds” are non-voice audio tracks but may include instrumental music, in which case the UI 69 may also include an entry such as the “new wave” music selection as shown.

Once a desired sleep sound is selected, the UI 70 of FIG. 4 may be presented, permitting a user, by means of the RC 27 for example, to input an on time, at which time of day the selected audio will automatically start to be streamed/played on the speakers 20. The user may also select an off time, at which time play of the audio will be terminated. As an alternative to selecting a particular sleep sound from FIG. 3, as shown in FIG. 4 the user may be given the option of selecting a particular audio channel. The channels, although labeled “A”, “B”, and “C” in FIG. 4 for simplicity, typically may carry labels indicating their genre, e.g. “white noise”, “ocean waves”, etc.

In some embodiments the user may pre-set a volume level for the sleep sound that is different from whatever the current volume level of the TV is. A UI may be provided to allow volume level selection. The UI may also permit a “fade” selection which would permit the user to select for the volume to be lowered over time, e.g., by one volume setting every five minutes, or slow, continuous fading, etc. Or, a UI may be presented from which the user can select a particular audio variation over time, i.e., a “sound curve”, with different curves being intended to match corresponding sleep patterns.

FIG. 5 shows example logic for implementing present principles. At block 72, at the selected “on” time from the UI 70 of FIG. 4, the audio server 32, if not already in communication with the TV 12, is contacted by the TV 12 over the network interface 30. The selected audio is downloaded as by, e.g., streaming at block 76 and presented on the speakers 20.

Decision diamond 78 indicates that if the TV 12 determines it is time to enter a TV sleep mode after, for instance, a predetermined period of inactivity or other power conservation criterion, the video display 18 is deenergized in accordance with TV power conservation principles at block 80. However, as indicated at block 80, any audio muting programmed as part of the power conservation logic of the TV is overridden and the selected sleep sound continues to be played on the speakers 20 until the user-selected “off” time from FIG. 4 is reached at decision diamond 82, at which time the logic ends at state 84 by ceasing the playing of the audio on the speakers. Because FIG. 5 is cast in non-limiting example logic flow format, various loops are shown, e.g., from a negative test at decision diamond 78 to decision diamond 82 and from a negative test at decision diamond 82 to decision diamond 78, it being understood that present logic may be implemented as state-drive logic.

In one implementation, the logic may use selection of “sleep sounds” from the UT 68 of FIG. 2 as an indicator that power savings muting should be overridden at block 80. In another implementation, “sleep sounds” may not be selected per se but rather mere selection of a sleep sound channel can be used an indicator that power savings muting should be overridden at block 80.

It may now be appreciated an audio stream may be received by the TV 12 (or other CE device in accordance with present principles) via the Internet or home media server and then decoded, its duration managed at a user-selected fading/volume level, to aid a user listening to the sleep sound in falling asleep.

Thus two electronic products, one of them being a bed time sound machine and the other a TV or baby monitor or other CE device, are incorporated into a single product. Also, unique sound profiles may be created and tailored to specific “sleep curves” (studies for better sleep) where sound levels are modulated throughout the night to match a person's sleep habits (for example). Then, in the morning, a final alarm could used wake up the user. This profile can be used in a TV, alarm clock, or other such device.

The logic above may be implemented by a “widget” on a user's desktop or TV or clock or other device making quick user access available. By “widget” is meant a portable module of computer software, or application, that can be installed and executed within, for example, a HTML-based web page by an end user without requiring compilation. Widgets can take the form of on-screen tools.

While the particular INTERNET-SOURCED BEDTIME AUDIO is herein shown and described in detail, it is to be understood that the subject matter which is encompassed by the present invention is limited only by the claims. For example, while the logic above is divulged using the TV as an example, it can also be implemented on the baby monitor, digital alarm clock, or other CE device.

What is claimed is:

1. Consumer electronic (CE) device comprising:
housing;
display on the housing;
at least one speaker;
network interface;
processor controlling the display and speaker and communicating with the Internet through the network interface;
the processor executing logic including:
presenting, on the display, a user interface (UI) from which a user can select an “on” time;
presenting, on the display, a UI from which a user can select a sleep sound, the sleep sound being an audio program that is a non-voice audio track;
at the on time, automatically playing on the speaker the selected sleep sound from an Internet server; and
responsive to a determination that a power conservation criterion is present in the device, deenergizing the display and overriding audio muting of the speaker programmed as part of power conservation logic to be muted in the presence of the power conservation criterion to continue playing the sleep sound on the speaker.

2. The device of claim 1, wherein the sleep sound is played on the speaker until a user-selected “off” time is reached, at which time the logic ceases playing of the sleep sound on the speaker.

3. The device of claim 1, wherein the sleep sound does not include voice or instrumental music but includes only sounds occurring naturally in nature, and/or white noise.

4. The device of claim 1, wherein at the “on” time streaming of the sleep sound from the Internet server is commenced.

5. The device of claim 1, wherein the device is an Internet-enabled TV.

6. The device of claim 1, wherein the device is a digital clock radio.

7. The device of claim 1, wherein the device is a digital baby monitor including a video camera.

8. Method comprising:
establishing communication between an audio player and an Internet server; and
downloading, from the Internet, sleep sound audio from the server to the player for playing the sleep sound audio to help people fall asleep or for aural therapy.

9. The method of claim 8, wherein the sleep sound audio is a non-voice natural or white noise sound.

10. The method of claim 8, wherein the player is a digital clock radio.

11. The method of claim 8, wherein the player is a digital baby monitor.

12. The method of claim 8, wherein the player is a TV and the method includes:
responsive to a determination that a power conservation criterion is present in the TV, deenergizing a video display of the TV and overriding audio muting of a speaker on the TV programmed as part of power conservation logic to be muted in the presence of the power conservation criterion to continue playing the sleep sound on the speaker.

13. Device comprising:
housing;
display on the housing;
at least one speaker;
network interface;
processor controlling the display and speaker and communicating with the Internet through the network interface;
the processor executing logic including:
presenting a user interface on the display listing genres of audio video content sources and, for each source in sub-menu style, genre of programming provided by that source, one of the sources being the Internet and one of the respective genres of programming being “sleep sounds”; responsive to a user selection of “sleep sounds” presenting on the display a UI from which a user may select a particular audio including white noise sounds and naturally occurring sounds; and
presenting on the display a UI permitting a user to input an on time of day, at which time of day selected audio is automatically streamed from the server and played on the speaker.

14. The device of claim 13, comprising presenting on the display a UI permitting a user to input an off time, at which off time play of the audio is terminated.

15. The device of claim 13, wherein the user selects a genre of programming by selecting a channel from a list of channel presented on the display.

16. The device of claim 13, wherein the device receives user selection of a pre-set a volume level for a selected sleep sound that is different from a current volume level of the speaker.

17. The device of claim 16, wherein the device receives user selection of a “fade” selection which causes the volume of the speaker to be automatically changed over time.

18. The device of claim 13, wherein the device is a TV.

19. The device of claim 18, wherein the logic includes:
responsive to a determination that a power conservation criterion is present in the device, deenergizing the display and overriding audio muting of the speaker programmed as part of power conservation logic to be muted in the presence of the power conservation criterion to continue playing the sleep sound on the speaker.
